(19) United States
(12) Patent Application Publication
(10) Pub. No.: US 2006/0052496 A1
(43) Pub. Date: Mar. 9, 2006

(54) Adduct of thiol and maleimide

(76) Inventors: Wonmun Choi, Kanagawa (JP); Fumito Yatsuyanagi, Kanagawa (JP)

Correspondence Address: RADER FISHMAN & GRAUER PLLC, LION BUILDING, 1233 20TH STREET N.W., SUITE 501, WASHINGTON, DC, 20036, US

(21) Appl. No.: 10/935,282

(22) Filed: Sep. 8, 2004

(51) Int. Cl. B32B 7/12

(52) U.S. Cl. 524/186

(57) ABSTRACT

A maleimide adduct of the present invention is a maleimide adduct represented by the following formula (1) or (2). This can improve a reaction at low temperature at the time of combination, decrease in workability due to scorching of rubbers at the time of roll kneading or the like, and physical property deterioration of vulcanized rubbers due to reversion, which have been problematic in the conventional rubber compositions.

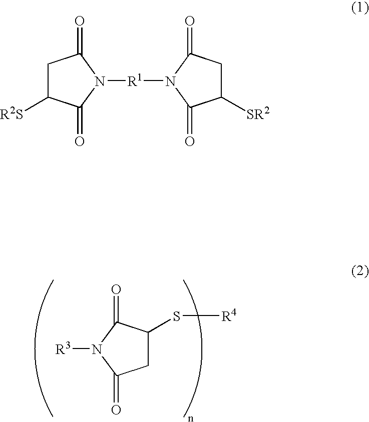

### BACKGROUND OF THE INVENTION

1. Field of the Invention

The present invention relates to a maleimide adduct which can be used as a protecting group of a thiol compound and a maleimide compound and is a reactant of the thiol compound and the maleimide compound. The present invention also relates to a rubber composition containing the maleimide adduct which can be used as a vulcanization accelerator. Further, the present invention relates to a resin composition containing the maleimide adduct.

2. Description of Related Art

Known examples of a compound used for a rubber composition include a compound including one or more thiol groups in a molecule. However, the thiol group is an extremely highly reactive substituent, and thus it easily reacts with an epoxy group, an isocyanate group, a double bond in a rubber molecule, and the like in the presence of a catalyst such as a metal oxide or an amine compound. There has been a problem in that the thiol group becomes a cause of decrease in workability, e.g., macromolecularization occurs owing to a self-oxidation reaction or the like.

Meanwhile, JP 2000-248115 A and JP 2001-64443 A each describe that by combining a bismaleimide compound with a rubber composition, not only the heat resistance but also a dynamic storage elastic modulus (E′) of the rubber become high, and that when the rubber composition is used for a tread, operation stability is enhanced. However, when bismaleimide is combined at a large amount with rubber, there has been a problem in that a vulcanization reaction is inhibited by bismaleimide or bismaleimide is degraded by a reaction with a vulcanization accelerator to gasify.

There has been also a problem in that scorching of rubber takes place at the time of roll kneading due to a vulcanization accelerator combined in the rubber composition to decrease workability or curing (vulcanization) of the rubber excessively progresses at the time of vulcanization to cause reversion.

### SUMMARY OF THE INVENTION

The present invention makes it an object to provide a maleimide adduct where a highly reactive thiol group is protected and to provide a rubber composition and a resin composition which contain the maleimide adduct, for solving the above problems in the conventional rubber compositions.

The inventors of the present invention have found that a maleimide adduct obtained by a reaction of a certain thiol compound with a certain maleimide compound can solve the above problems, thereby completing the present invention. That is, the present invention provides maleimide adducts, and rubber compositions and resin compositions which contain the maleimide adducts described in the following (1) to (6).

(1) A maleimide adduct represented by the following formula (1): 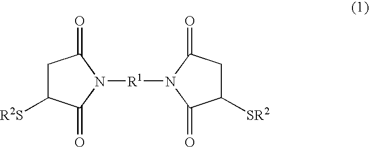
(wherein, R¹ represents an acyclic aliphatic group having 1 to 24 carbon atoms which may have a substituent, a cyclic aliphatic group having 5 to 18 carbon atoms which may have a substituent, an aromatic group having 6 to 18 carbon atoms which may have a substituent, or an alkyl aromatic group having 7 to 24 carbon atoms which may have a substituent, and may include at least one hetero element selected from the group consisting of SO₂, O, N and S, and R²'s each independently represent an organic group having 1 to 24 carbon atoms which have no active hydrogen group and may have a substituent).

(2) A maleimide adduct represented by the following formula (2): 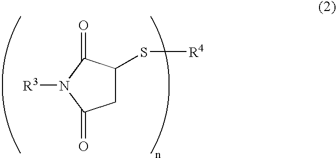
(wherein, n represents an integer of 1 to 4, R³ represents a hydrogen atom, an acyclic aliphatic group having 1 to 24 carbon atoms which may have a substituent, a cyclic aliphatic group having 5 to 18 carbon atoms which may have a substituent, an aromatic group having 6 to 18 carbon atoms which may have a substituent, or an alkyl aromatic group having 7 to 24 carbon atoms which may have a substituent, and may include at least one hetero element selected from the group consisting of SO₂, O, N, and S, multiple R³'s may be identical to or different from each other, and R⁴ represents an organic group having 1 to 24 carbon atoms which may have a substituent).

(3) A rubber composition containing the maleimide adduct according to (1) or (2).

(4) A resin composition containing the maleimide adduct according to (1) or (2).

(5) A method of producing the maleimide adduct according to (1) including reacting a compound (A) containing one thiol group in one molecule with a bismaleimide compound (B) to obtain the maleimide adduct.

(6) A method of producing the maleimide adduct according to (2) including reacting a compound (C) containing one or more thiol groups in one molecule with one or more maleimide compounds (D) to obtain the maleimide adduct.

As described below, the use of the maleimide adduct of the present invention, where a highly reactive thiol group is protected, for rubber composition and resin compositions results in compositions having excellent workability. In particular, when the maleimide adduct of the present invention is used as a vulcanization accelerator in a rubber composition, a reaction at low temperature, scorching of rubber composition during the time of mixing and kneading, and reversion of vulcanization are improved. This facilitates utilization of the rubber composition and the resin composition which utilize high reactivity of the thiol group, and thus the rubber composition and the resin composition using the maleimide adduct of the present invention are very useful.

### BRIEF DESCRIPTION OF THE DRAWINGS

FIG. 1 shows relationships of a vulcanizing time with a torque when rubber compositions of Comparative Example 1 and Examples 3 and 4 are vulcanized at 160° C. for 60 min.

FIG. 2 shows relationships of a vulcanizing time with a torque when rubber compositions of Comparative Example 1 and Examples 3 and 4 are vulcanized at 180° C. for 60 min.

FIG. 3 is a result of tensile tests of rubber compositions of Comparative Examples 2 and 3 and Examples 5 and 6 after vulcanization.

### DETAILED DESCRIPTION OF THE INVENTION

Hereinafter, the present invention is described in detail.

The maleimide adduct according to a first aspect of the present invention (hereinafter referred to as “the first maleimide adduct of the present invention”) is a maleimide adduct represented by the following formula (1).

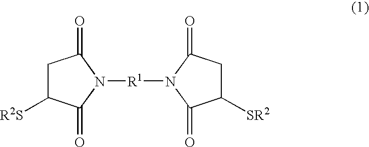

In the formula, R¹ represents an acyclic aliphatic group having 1 to 24 carbon atoms which may have a substituent, a cyclic aliphatic group having 5 to 18 carbon atoms which may have a substituent, an aromatic group having 6 to 18 carbon atoms which may have a substituent, or an alkyl aromatic group having 7 to 24 carbon atoms which may have a substituent, and may include at least one hetero element selected from a group consisting of SO₂, O, N, and S. When R¹ has a substituent, the substituent is not particularly limited in the present invention.

Examples of R¹ include divalent groups excluding a maleimide group of the bismaleimide compound described below such as an ethylene group, a 1,6-hexyl group, a 1,2-phenyl group, a 1,3-phenylene group, a 1,4-phenylene group, a tolyl group, a diphenyl group, a ditolyl group, a 4,4′-diphenylmethane group, and a sulfonylbis(1,3-phenylene) group. Of those, a 1,6-hexyl group, a 4,4′-diphenylmethane group, and a sulfonylbis(1,3-phenylene) group are preferable.

R²'s each independently represent an organic group having 1 to 24 carbon atoms which have no active hydrogen group and may have a substituent. It is preferable that each R² includes at least one hetero element selected from a group consisting of SO₂, O, N, and S. Here, the organic group is an alkyl, cycloalkyl, aryl group, or the like which may or may not be substituted with at least one atomic group selected from a group consisting of cycloalkyl, alkoxy, cycloalkoxy, aryl, aryloxy, alkanoyloxy, and aralkyloxy groups, and a halogen atom. Each R² is preferably an oxyalkyl, aliphatic hydrocarbon, aromatic, or heterocyclic group, and may be a substituent formed by combining them. From a reason that each R² is susceptible to heat dissociation as described below, each R² is preferably an aromatic group or a heterocyclic group. When an R² has a substituent, the substituent is not particularly limited in the present invention, but an alkyl group and a halogen atom are preferable.

Examples of R² include monovalent groups excluding a thiol group of the thiol group-containing compound (A) described below such as a methyl group, an ethyl group, a 1-propyl group, a 2-methyl-1-propyl group, a 1-butyl group, a phenyl group, a 2-thiazole group, a 2-thiazoline group, and a 2-benzothiazole. Of those, a phenyl group, a 2-thiazoline group, and a 2-benzothiazole group are preferable.

It is preferred that the first maleimide adduct of the present invention be a maleimide adduct obtained by reacting a compound (A) containing one thiol group in one molecule with a bismaleimide compound (B).

Here, the above compound (A) containing one thiol group in one molecule (hereinafter referred to as a “thiol group-containing compound (A)”) is a compound made up of an organic group having no group having active hydrogen but thiol group, and having 1 to 24 carbon atoms which may have a substituent and one thiol group, and it is preferable that the compound (A) include at least one hetero element selected from a group consisting of SO₂, O, N, and S. When the compound (A) has a substituent, the substituent is not particularly limited so long as the substituent does not affect a reaction with the bismaleimide compound (B), but an alkyl group and a halogen atom are preferable. Here, the organic group is the same as that defined for the organic group in the above R².

Of those, specific examples of the thiol group-containing compound (A) include methanethiol, ethanethiol, 1-propanethiol, 2-methyl-1-propanethiol, 2-methyl-2-propanethiol, 1-butanethiol, 2-butanethiol, 2-methyl-2-butanethiol, 2-methyl-1-butanethiol, 1-hexanethiol, 1-heptanethiol, 1-decanethiol, 1-dodecanethiol, n-hexadecanethiol, tert-hexadecanethiol, n-octadecanethiol, cyclopentanethiol, cyclohexanethiol, benzenethiol (thiophenol), 4-bromobenzenethiol, 3-chlorobenzenethiol, 4-chlorobenzenethiol, 2-fluoroobenzenethiol, 3-fluorobenzenethiol, 4-fluorobenzenethiol, 3-methoxybenzenethiol, 4-methoxybenzenethiol, 4-nitrothiophenol, 3,4-dichlorobenzenethiol, 2,3-dichlorobenzenethiol, 2,6-dichlorobenzenethiol, 3,5-dichlorobenzenethiol, 2,4-dichlorobenzenethiol, 2,4-dimethylbenzenethiol, 2,5-dimethylbenzenethiol, 2-naphthalenethiol, 2-mercaptobenzothiazole, 5-methyl-2-mercaptobenzothiazole, 5-methoxy-2-mercaptobenzothiazole, 5-chloro-2-mercaptobenzothiazole, 5-bromo-2-mercaptobenzothiazole, 6-methyl-2-mercaptobenzothiazole, 6-methoxy-2-mercaptobenzothiazole, 6-ethoxy-2-mercaptobenzothiazole, 6-chloro-2-mercaptobenzothiazole, 2-mercaptothiazole, 2-mercaptothiazoline, 5-methyl-1,3,4-thiazole-2-thiol, 2-mercaptobenzoxazole, and 1-phenyl-1H-tetrazole-5-thiol.

Of those, an aromatic thiol group-containing compound (Hereinafter, referred to as an “aromatic thiol”) or a thiol group-containing heterocyclic compound (Hereinafter, referred as a “heterocyclic thiol”) is preferable because the compound is effective for utilizing heat dissociation property as described below.

Further, 2-mercaptobenzothiazole, 5-methyl-2-mercaptobenzothiazole, 5-methoxy-2-mercaptobenzothiazole, 5-chloro-2-mercaptobenzothiazole, 5-bromo-2-mercaptobenzothiazole, 6-methyl-2-mercaptobenzothiazole, 6-methoxy-2-mercaptobenzothiazole, 6-ethoxy-2-mercaptobenzothiazole, or 6-chloro-2-mercaptobenzothiazole is preferably used as the thiol group-containing compound (A) because the compound works as a vulcanization accelerator after heat dissociation described below. 2-mercaptobenzothiazole is more preferably used.

Next, the above bismaleimide compound (B) is not particularly limited as long as it reacts with the above thiol group-containing compound (A) and is a bismaleimide compound that may form a maleimide adduct represented by the above formula (1).

Specific examples of the bismaleimide compound (B) include 1,2-bismaleimidoethane, 1,6-bismaleimidohexane, N,N′-1,2-phenylene dimaleimide, N,N′-1,3-phenylene dimaleimide, N,N′-1,4-phenylene dimaleimide, N,N′-1,4-phenylene-2-methyl dimaleimide, N,N′-(1,1′-biphenyl-4,4′-diyl)bismaleimide, N,N′-(3,3′-dimethyl-1,1′-biphenyl-4,4′-diyl)bismaleimide, 4,4′-diphenylmethane bismaleimide, N,N′-(methylenebis(2-chloro-4,1-phenylene))bismaleimide, bis(3-ethyl-5-methyl-4-maleimidophenyl)methane (trade name: BMI-70 (available from K.I CHEMICAL INDUSTRY CO., LTD.)), 2,2-bis(4-(4-maleimidophenoxy)phenyl)propane, N,N′-(sulfonylbis(1,3-phenylene))dimaleimide, and N,N′-(4,4′-trimethylene glycol dibenzoate)bismaleimide. Further, the bismaleimide compound (B) may be a maleimide-modified polymer compound (such as resin or rubber).

Of those, 1,6-bismaleimidohexane, 1,2-bismaleimidoethane, N,N′-1,3-phenylene dimaleimide, and 4,4′-diphenylmethane bismaleimide are preferably used for economical reasons.

It is preferred that the reaction of the above thiol group-containing compound (A) with the bismaleimide compound (B) be performed by adding the thiol group-containing compound (A) at twice equivalent to the bismaleimide compound (B), and stirring the mixture in an organic solvent at room temperature to 150° C. for 1 to 24 hours. Here, the organic solvent may be any of those which solubilize both the above thiol group-containing compound (A) and the above bismaleimide compound (B), and acetone, methyl ethyl ketone, N-methyl-2-pyrrolidone, tetrahydrofuran, and N,N-dimethylformamide are preferably exemplified. Of those, methyl ethyl ketone and N,N-dimethylformamide are preferable because they exhibit high solubility.

The maleimide adduct represented by the above formula (1) is obtained by concentrating/eliminating the organic solvent under reduced pressure after the completion of the reaction.

In view of the above, specific examples of the maleimide adduct represented by the above formula (1) include combinations of respective specific examples of the aforementioned thiol group-containing compound (A) and bismaleimide compound (B). Of those, a compound represented by the following formula (3) which is a reactant of 2-mercaptobenzothiazole and 1,6-bismaleimidohexane, a compound represented by the following formula (4) which is a reactant of 2-mercaptobenzothiazole and N,N′-1,3-phenylenedimaleimide, a compound represented by the following formula (5) which is a reactant of 2-mercaptobenzothiazole and 4,4′-diphenylmethanemaleimide, and the like are preferably exemplified by the reason that they are susceptible to heat dissociation as described below. The compounds represented by the following formulae (3), (4), and (5) are preferable also for economic reasons.

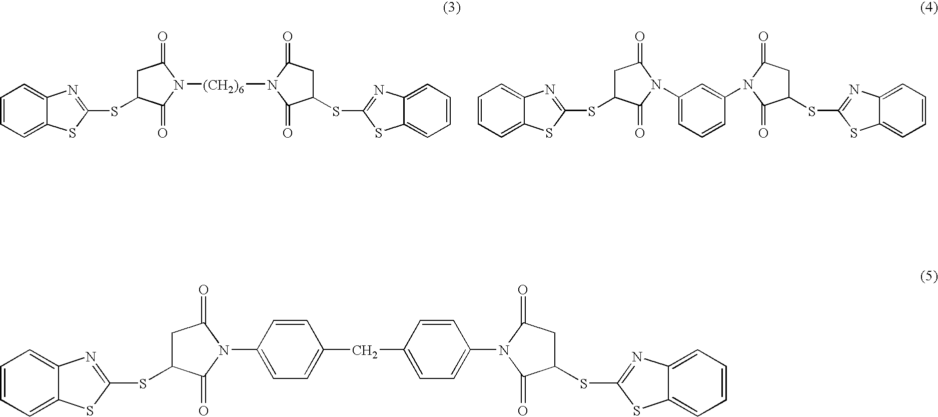

The maleimide adduct according to a second aspect of the present invention (hereinafter referred to as “the second maleimide adduct of the present invention”) is a maleimide adduct represented by the following formula (2).

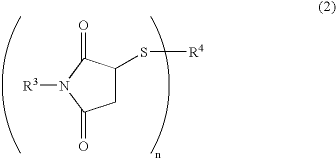

In the formula, n represents an integer of 1 to 4, R³ represents a hydrogen atom, an acyclic aliphatic group having 1 to 24 carbon atoms which may have a substituent, a cyclic aliphatic group having 5 to 18 carbon atoms which may have a substituent, an aromatic group having 6 to 18 carbon atoms which may have a substituent, or an alkyl aromatic group having 7 to 24 carbon atoms which may have a substituent, and may include at least one hetero element selected from a group consisting of SO₂, O, N, and S. When an R³ has a substituent, the substituent is not particularly limited in the present invention. Furthermore, when n is an integer of 2 to 4, multiple R³'s may be identical to or different from each other.

Examples of R³ include monovalent groups excluding a maleimide group of the maleimide compound (D) described below such as a hydrogen atom, a methyl group, an ethyl group, a 1-propyl group, a 1-butyl group, a cyclohexyl group, and a phenyl group. Of those, a cyclohexyl group and a phenyl group are preferable.

R⁴ represents an organic group having 1 to 24 carbon atoms which may have a substituent. It is preferable the R⁴ include at least one hetero element selected from a group consisting of SO₂, O, N, and S. Here, the organic group is an alkyl, cycloalkyl, aryl group, or the like which may or may not be substituted with at least one atomic group selected from a group consisting of cycloalkyl, alkoxy, cycloalkoxy, aryl, aryloxy, alkanoyloxy, and aralkyloxy groups, and a halogen atom, similarly to the organic group in the above R². R⁴ is preferably an oxyalkyl, aliphatic hydrocarbon, aromatic, or heterocyclic group, and may be a substituent formed by combining them. From a reason that R⁴ is susceptible to heat dissociation as described below, R⁴ is preferably an aromatic group or a heterocyclic group. Also, when R⁴ has a substituent, the substituent is not particularly limited, but an alkyl group and a halogen atom are preferable.

Examples of R⁴ include groups of monovalent or more excluding a thiol group of the thiol group-containing compound (C) described below such as a methyl group, a methylene group, a 2-aminoethyl group, a 2-aminoethylene group, a 2-aminophenyl group, a 1-propyl group, a 1,4-butylene group, a 1,6-hexyl group, a 1,10-decyl group, a phenyl group, a 1,3-phenylene group, a 1,5-naphthyl group, a triazine group, a 2-imidazole group, and a 2-benzothiazole group. Of those, a 2-benzothiazole group, a triazine group, and a 2-imidazole group are preferable.

It is preferred that the second maleimide adduct of the present invention be a maleimide adduct obtained by reacting a compound (C) containing one or more thiol groups in one molecule with one or more maleimide compounds (D).

The above compound (C) containing one or more thiol groups in one molecule (hereinafter referred to as a “thiol group-containing compound (C)”) is a compound made up of an organic group having 1 to 24 carbon atoms which may have a substituent and one or more thiol groups, and it is preferable that the compound (C) include at least one hetero element selected from a group consisting of SO₂, O, N, and S. When the compound (C) has a substituent, the substituent is not particularly limited so long as the substituent does not affect a reaction with the one or more maleimide compounds (D), but an alkyl group and a halogen atom are preferable. Here, the organic group is the same as that defined for the organic group in the above R⁴.

Of those, specific examples of the thiol group-containing compound (C) include the compounds exemplified as the above thiol group-containing compound (A). Further, examples of the thiol group-containing compound (C) may include compounds having active hydrogen except in the thiol group such as 2-aminoethanethiol, 2-pyridinethiol, 4-pyridinethiol, 2-aminobenzenethiol, 4-aminobenzenethiol, 4-hydroxybenzenethiol, 2-mercaptoimidazole, 2-mercaptoimidazoline, 2-mercaptobenzimidazole, 2-mercapto-5-methoxybenzimidazole, 5-amino-1,3,4-thiadiazole-2-thiol, 3-amino-5-mercapto-1,2,4-triazole, and 5-methyl-1H-1,2,4-triazole-3-thiol. Other examples thereof include compounds each containing two or more thiol groups in one molecule such as methanedithiol, 1,3-butanedithiol, 1,4-butanedithiol, 2,3-butanedithiol, 1,2-benzenedithiol, 1,3-benzenedithiol, 1,4-benzenedithiol, 1,10-decanedithiol, 1,2-ethanedithiol, 1,6-hexanedithiol, 1,9-nonanedithiol, 1,8-octanedithiol, 1,5-pentanedithiol, 1,2-propanedithiol, 1,3-propanedithiol, toluene-3,4-dithiol, 3,6-dichloro-1,2-benzenedithiol, 1,5-naphthalenedithiol, 1,2-benzene dimethanethiol, 1,3-benzene dimethanethiol, 1,4-benzene dimethanethiol, 4,4′-thiobisbenzenethiol, 2,5-dimercapto-1,3,4-thiadiazole, 1,8-dimercapto-3,6-dioxaoctane, 1,5-dimercapto-3-thiapentane, 1,3,5-triazine-2,4,6-trithiol(trimercapto-triazine), 2-di-n-butylamino-4,6-dimercapto-s-triazine, trimethylolpropane tris(β-thiopropionate), trimethylolpropane tris(thioglycolate), and polythiol (thiokol or a thiol-modified polymer (such as resin or rubber)).

Of those, aromatic thiol or heterocyclic thiol are preferable because the compound is effective for utilizing heat dissociation property as described below. Preferable specific examples thereof include 2,5-dimercapto-1,3,4-thiadiazole, 2-di-n-butylamino-4,6-dimercapto-s-triazine, and trimercapto-triazine.

Further, 2,5-dimercapto-1,3,4-thiadiazole or 2-di-n-butylamino-4,6-dimercapto-s-triazine is preferably used because the compound is a solid having no odor and thus is easily handled and is susceptible to heat dissociation as described below.

Next, the above maleimide compound (D) is not particularly limited so long as it is a maleimide compound which reacts with the above thiol group-containing compound (C) to yield the maleimide adduct represented by the above formula (2).

A known N-substituted maleimide can be used as the maleimide compound (D), but preferable examples thereof include: N-alkyl group-substituted maleimide such as N-methylmaleimide, N-ethylmaleimide, N-propylmaleimide, N-butylmaleimide, N-hexylmaleimide, and N-dichlorohexylmaleimide; N-cycloalkyl-substituted maleimide such as N-cyclohexylmaleimide; and N-phenylmaleimide. Of those, N-cyclohexylmaleimide and N-phenylmaleimide are preferable for economical reasons.

It is preferred that the reaction of the above thiol group-containing compound (C) with the maleimide compounds (D) be performed by adding the one or more maleimide compounds (D) at 0.90 to 4.10 time equivalent, preferably 0.95 to 4.05 time equivalent to the thiol group-containing compound (C), and stirring the mixture in an organic solvent at room temperature to 150° C. for 1 to 24 hours. Here, the organic solvent may be any of those which solubilize both the above thiol group-containing compound (C) and the above bismaleimide compounds (D), and acetone, methyl ethyl ketone, N-methyl-2-pyrrolidone, tetrahydrofuran, and N,N-dimethylformamide are preferably exemplified. Of those, methyl ethyl ketone and N,N-dimethylformamide are preferable because they exhibit high solubility.

The maleimide adduct represented by the above formula (2) is obtained by concentrating/eliminating the organic solvent under reduced pressure after the completion of the reaction.

In view of the above, specific examples of the maleimide adduct represented by the above formula (2) include combinations of respective specific examples of the aforementioned thiol group-containing compound (C) and bismaleimide compound (D). Of those, a compound represented by the following formula (6) which is a reactant of 2-mercaptobenzothiazole and N-phenylmaleimide, a compound represented by the following formula (7) which is a reactant of 2-mercaptobenzothiazole and N-cyclohexylmaleimide, a compound represented by the following formula (8) which is a reactant of 2-di-n-butylamino-4,6-dimercapto-s-triazine and N-phenylmaleimide, a compound represented by the following formula (9) which is a reactant of thiophenol and N-phenylmaleimide, a compound represented by the following formula (10) which is a reactant of 2,5-dimercapto-1,3,4-thiadiazole and N-phenylmaleimide, and the like are preferably exemplified.

Of those, the compounds represented by the following formulae (6) and (7) are preferable because the thiol group works as a vulcanization accelerator after the heat dissociation described below, and the compounds represented by the following formulae (8) and (10) are preferable because two thiol groups are produced after the heat dissociation described below.

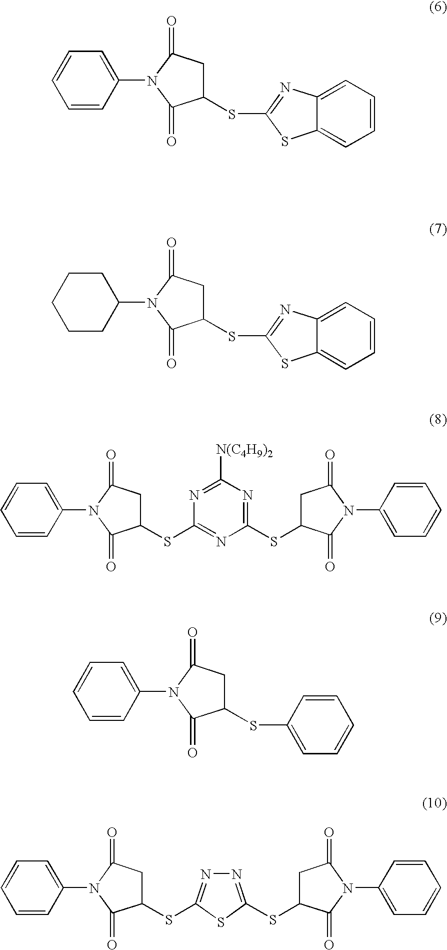

The maleimide adducts represented by the above formulae (1) and (2) each have an effect that the heat dissociation takes place by being heated at 150 to 250° C., preferably 160 to 200° C. A heat dissociation time period is preferably from 1 to 60 min, and more preferably from 1 to 30 min.

The heat dissociation occurs at a site composed of the maleimide compound in the above maleimide adduct.

Therefore, when the maleimide adducts represented by the above formulae (1) and (2) are subjected to heat dissociation, compounds represented by the following two formulae (11) and (12) are separated/produced from the maleimide adduct represented by the above formula (1), and a compound represented by the following formula (13) and n compounds represented by the formula (14) are separated/produced from the maleimide adduct represented by the above formula (2).

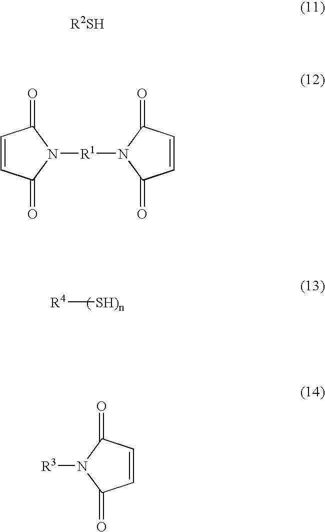

In the formulae, R¹, R², R³, R⁴, and n are the same as those defined for R¹, R², R³, R⁴ , and n described in the above formulae (1) and (2).

Specific examples of the compounds represented by the above formulae (11), (12), (13), and (14) include, but are not limited to, the compounds exemplified in the thiol group-containing compound (A), the bismaleimide compound (B), the thiol group-containing compound (C), and the maleimide compound (D) aforementioned, respectively.

The compounds represented by the above formulae (11) and (13) are highly reactive because they have thiol groups, and thus there has been a problem in that a reaction at low temperature, scorching of rubber composition during the time of mixing and kneading, reversion of vulcanization and the like take place when the compounds are combined with a rubber composition, a resin composition, and the like.

The compounds represented by the above formulae (12) and (14) have posed a problem in that the vulcanization is delayed at the time of rubber vulcanization or a single polymerization reaction occurs.

In contrast, in the present invention, by separating/producing the compounds represented by the above formulae (11), (12), (13), and (14) by virtue of the heat dissociation after combining the maleimide adduct of the present invention with the composition, it has become possible to prevent a reaction at low temperature, scorching of rubber composition during the time of mixing and kneading, reversion of vulcanization, single polymerization reaction, and the like. That is, the compounds represented by the above formulae (1) and (2) work as protecting groups of the thiol groups of the compounds represented by the above formulae (11) and (13) at a heat dissociation temperature or below.

Therefore, it is preferred that the maleimide adduct of the present invention be manufactured in consideration of natures of the compounds represented by the above formulae (11) and (13) separated/produced after the heat dissociation. Specifically, the maleimide adducts of the present invention represented by the following formulae (15) and (16) using 2-mercaptobenzothiazole which works as a vulcanization accelerator for sulfur vulcanized rubbers are preferable because it becomes possible to prevent a reaction at low temperature at the time of combination to enhance the workability when they are used as vulcanization accelerators for the rubber compositions. As is shown in Examples described below, compared to the cases where 2-mercaptobenzothiazole and 1,6-bismaleimidohexane are separately used, favorable results that a long Mooney scorch time of rubber composition, a low tensile stress at low strain of vulcanized rubber, and further a high elongation at break are obtained.

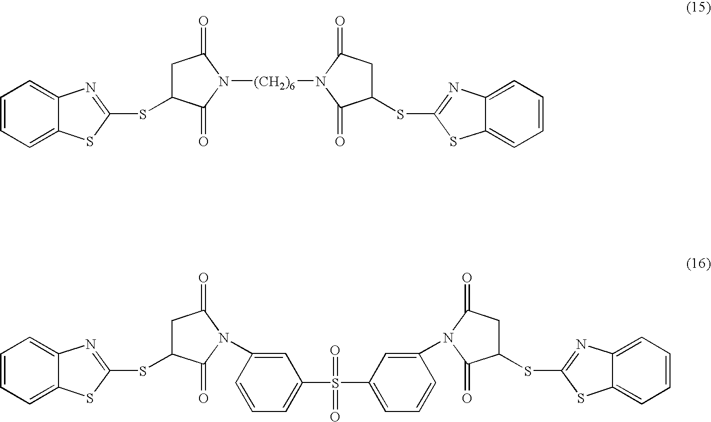

As described above, the compounds represented by the above formulae (1) and (2) work as the protecting groups of the thiol groups of the compounds represented by the above formula (11) and (13), whereas they work as the protecting groups of the maleimide groups of the compounds represented by the above formulae (12) and (14) at the heat dissociation temperature or below.

A rubber composition of the present invention containing the above maleimide adduct is a composition containing a rubber component and the maleimide adduct of the present invention, and if necessary an additive.

Preferable examples of the rubber component used as a material of the rubber composition of the present invention include but are not limited to natural rubber (NR), isoprene rubber (IR), styrene-butadiene copolymer rubber (SBR), natural rubber/styrene-butadiene copolymer rubber (NR/SBR), natural rubber/butadiene rubber (NR/BR), natural rubber/acrylonitrile butadiene rubber (NR/NBR), natural rubber/chloroprene rubber (NR/CR), halogenated butyl rubber, polychlorinated rubber, halogenated polyethylene rubber, ethylene propylene rubber (EPDM), and epichlorohydrin rubber.

The above rubber component, if necessary, may be mixed with various additives such as a filler, a plasticizer, anti-oxidant, a vulcanization agent, a vulcanization accelerator, and a vulcanization assistant. Specific examples thereof include: a filler such as carbon black including HAF carbon and SAF carbon; a plasticizer such as aroma oil and wax; a vulcanization agent such as sulfur and zinc oxide; a vulcanization accelerator such as N-cyclohexyl-2-benzothiazole sulfenamide (CBS) and dibenzothiazyl disulfide (DM); and a vulcanization assistant such as stearic acid.

In the rubber composition of the present invention, a content of the above maleimide adduct is from 1 to 30 parts by weight, preferably from 1 to 20 parts by weight, and particularly preferably from 1 to 10 parts by weight based on 100 parts by weight of the rubber component. A content of the above maleimide adduct in this range is preferable because heat dissociation sites in the maleimide compound are sufficiently present, and thus a reaction with the above rubber component after the heat dissociation is easily carried forward.

A resin composition of the present invention containing the above maleimide adduct is a composition containing a resin, the maleimide adduct of the present invention, and if necessary an additive.

The resin used as a raw material of the resin composition of the present invention is not particularly limited, and the resins each of which reacts with thiol groups generated after the heat dissociation and has an epoxy, isocyanate, or vinyl group capable of forming crosslinking are suitably exemplified. Each of the resins can be used alone or two or more of them can be used in combination.

The resin composition of the present invention can contain one or two or more polymers in addition to the maleimide adduct of the present invention as long as the object of the present invention is not damaged, and if necessary can also further contain a compounding agent such as a plasticizer, filler, catalyst, solvent, ultraviolet absorbent, dye, pigment, flame retardant, reinforcer, age resistor, anti-oxidant, thixotropy imparting agent, surfactant (including a leveling agent), dispersant, dehydrating agent, antirust agent, adhesiveness imparting agent, or antistatic agent. Those usually used can be used for those compounding agents.

In the resin composition of the present invention, the content of the above maleimide adduct is from 1 to 300 parts by weight, preferably from 10 to 200 parts by weight, and particularly preferably from 10 to 100 parts by weight based on 100 parts by weight of the resin (base material). It is preferable that the content of the above maleimide adduct be in this range, because heat dissociation sites in the maleimide compound are sufficiently present and the reaction with the above resin after the heat dissociation is easily carried forward.

Methods of manufacturing the rubber composition and the resin composition of the present invention are not particularly limited, and for example, they are obtained by appropriately adding the above essential ingredients and optional ingredients into a reaction vessel, and thoroughly kneading the mixture under reduced pressure using an agitating machine such as a mixer.

The rubber composition and the resin composition of the present invention can be used for various bonding agents, adhesive compounds, paints, sealing materials, and the like.

Hereinafter, the present invention is described in detail by way of examples. However, the present invention is not limited thereto.

### EXAMPLE 1

Into 50 g of methyl ethyl ketone, 27.6 g (0.1 mol) of 1,6-bismaleimidohexane and 33.4 g (0.2 mol) of 2-mercaptobenzothiazole were added, and the whole was reacted at 100° C. for 12 hours. After completion of the reaction, methyl ethyl ketone was eliminated at 90° C. under reduced pressure to yield 60.5 g of a maleimide adduct (Adduct 1) represented by the following formula (15) (reaction yield 99%). ¹H-NMR (chloroform-d1) δ (ppm): 1.3-1.7, 3.0, 3.2-3.6, 4.5, 7.3-7.9.

### EXAMPLE 2

Into 70 g of methyl ethyl ketone, 40.8 g (0.1 mol) of N,N′-(sulfonylbis(1,3-phenylene))dimaleimide and 33.4 g (0.2 mol) of 2-mercaptobenzothiazole were added, and the whole was reacted at 100° C. for 12 hours. After completion of the reaction, methyl ethyl ketone was eliminated at 90° C. under reduced pressure to yield 73.2 g of a maleimide adduct (Adduct 2) represented by the following formula (16) (reaction yield 99%). ¹H-NMR (chloroform-d1) δ (ppm): 3.2-3.6, 4.5, 7.2-7.9.

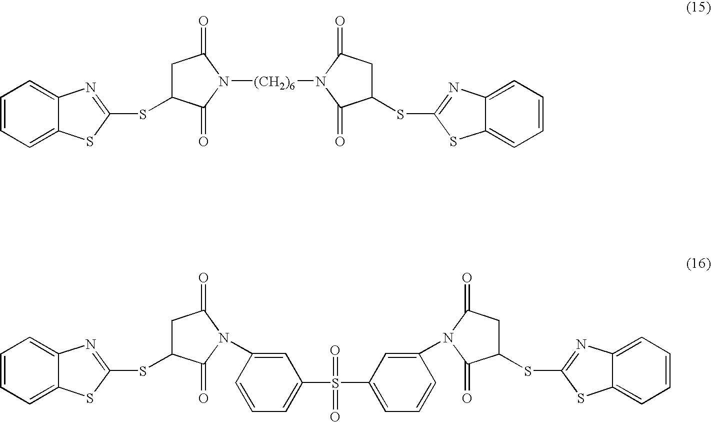

### EXAMPLES 3, 4, COMPARATIVE EXAMPLE 1

The resultant maleimide adducts (Adduct 1 and Adduct 2), polyisopropylene rubber, carbon black, zinc oxide, stearic acid, anti-oxidant, and sulfur were mixed to have composition components (parts by weight) shown in the following Table 1, and evenly dispersed with a mixer for high viscosity to make rubber compositions in Examples 3 and 4.

Polyisopropylene rubber, carbon black, zinc oxide, stearic acid, anti-oxidant, sulfur, and N-cyclohexyl-2-benzothiazole sulfenamide (CZ) were mixed to have composition components (parts by weight) shown in the following Table 1 without addition of the maleimide adduct, and evenly dispersed with a mixer for high viscosity to make a rubber composition in Comparative Example 1.

The following compounds were used as the above respective composition components.

Nipol IR 2200 (available from Zeon Corporation) was used as the polyisopropylene rubber, and SAF (available from Showa Black) was used as the carbon black.

LUYAC YA (available from NOF Corporation), Nocrac 224 (available from Ouchishinko Chemical Industrial Co., Ltd.), and powder sulfur (available from KK. Karuizawa Seirensho) were used as stearic acid, anti-oxidant, and sulfur, respectively.

TABLE 1

| | Comparative | | |
|---|---|---|---|
| | Example 1 | Example 3 | Example 4 |
| Polyisopropylene | 100 | 100 | 100 |
| rubber | | | |
| Carbon black | 50 | 50 | 50 |
| Zinc oxide | 3 | 3 | 3 |
| Stearic acid | 1 | 1 | 1 |
| Anti-oxidant | 1 | 1 | 1 |
| Sulfur | 1.5 | 0.75 | 0.75 |
| CZ | 1.5 | — | — |
| Adduct 1 | — | 3.5 | — |
| Adduct 2 | — | — | 4.3 |

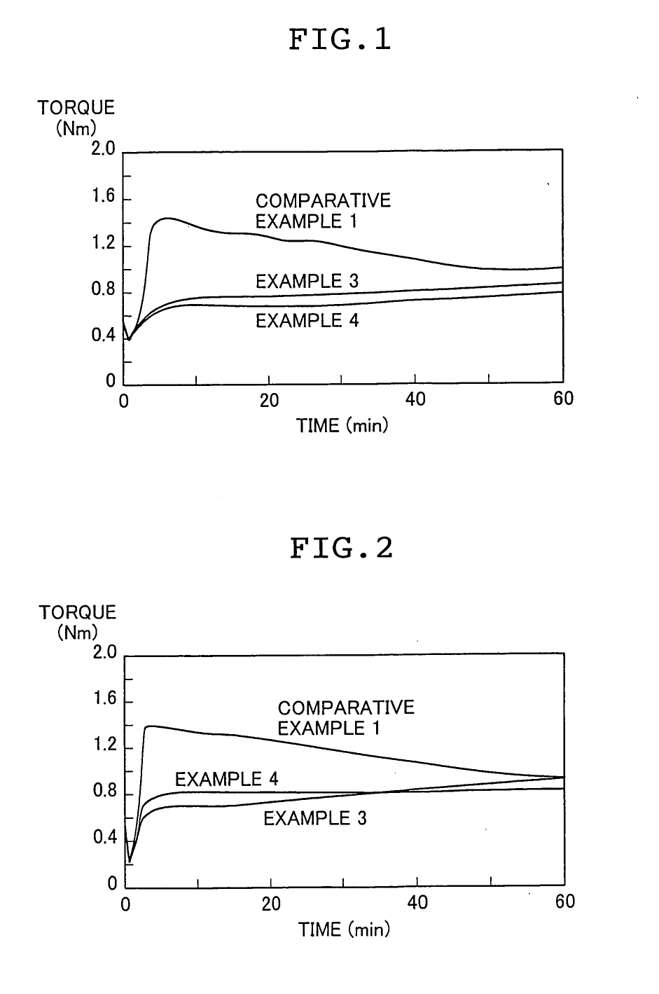

The rubber compositions in Comparative Example 1 and Examples 3 and 4 were examined for vulcanization property under conditions shown below. The results are shown in FIGS. 1 and 2.

<Vulcanization Property>

The rubber compositions in Comparative Example 1 and Examples 3 and 4 were vulcanized at 160° C. for 60 min or at 180° C. for 60 min, and a relationship of a vulcanizing time (min) with a torque (Nm) was measured in reference with JIS K6300-1994. Specifically, the relationship was measured at an amplitude angle of 1 degree and at a test temperature of 160° C. or 180° C. using a vibrating vulcanization test machine.

FIGS. 1 and 2 show that the rubber compositions in Examples 3 and 4 resulted in inhibiting the reversion which accompanies torque reduction, compared to the rubber composition in Comparative Example 1. In addition, the rubber composition in Example 3 resulted in slightly increasing the torque also over a last half of the vulcanization when vulcanized at 180° C. for 60 min as shown in FIG. 2.

### EXAMPLES 5 and 6, COMPARATIVE EXAMPLES 2 and 3

2-mercaptobenzothiazole (hereinafter abbreviated as “M”), 1,6-bismaleimidohexane (hereinafter abbreviated as “H-MI”), Adduct 2 (hereinafter abbreviated as “M-SO₂MI”) represented by the above formula (16), polyisopropylene rubber, carbon black, zinc oxide, stearic acid, anti-oxidant, and sulfur were mixed at composition components (parts by weight) shown in the following Table 2, and evenly dispersed with a mixer for high viscosity to make rubber compositions in Examples 5 and 6, and Comparative Examples 2 and 3.

The following compounds were used as the above respective composition components.

Nipol IR 2200 (available from Zeon Corporation) was used as the polyisopropylene rubber, and SAF (supplied from Showa Black) was used as the carbon black.

LUYAC YA (available from NOF Corporation), Nocrac 224 (available from Ouchishinko Chemical Industrial Co., Ltd.), and powder sulfur (available from KK. Karuizawa Seirensho) were used as stearic acid, age resistor, and sulfur, respectively.

TABLE 2

| | Compara- | Compara- | | |
|---|---|---|---|---|
| | tive | tive | Example | Example |
| | Example 2 | Example 3 | 5 | 6 |
| Polyisopropylene rubber | 100 | 100 | 100 | 100 |
| Carbon black | 50 | 50 | 50 | 50 |
| Zinc oxide | 3 | 3 | 3 | 3 |
| Stearic acid | 1 | 1 | 1 | 1 |
| Anti-oxidant | 1 | 1 | 1 | 1 |
| Sulfur | 1.5 | 1.5 | 1.5 | 1.5 |
| M | 1 | 1 | — | — |
| H-MI | — | 1 | — | — |
| M-SO₂MI | — | — | 1.5 | 2.2 |
| Mooney scorch | 16.5 | 8.3 | 15.8 | 16.1 |
| ML5UP@125° C. (Min) | | | | |
| Hardness test (A shape) | 63 | 72 | 62 | 64 |

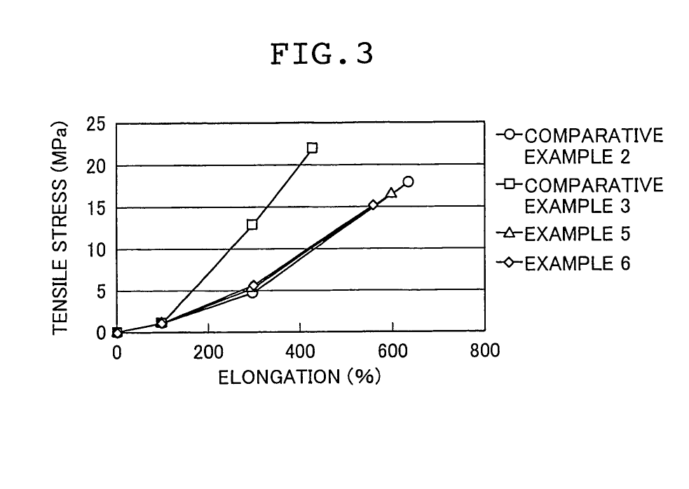

The rubber compositions in Comparative Examples 2 and 3, and Examples 5 and 6 were examined for physical properties before and after the vulcanization under conditions shown below. The results are shown in FIG. 3 and Table 2.

<Mooney Scorch Time>

In reference with JIS K6300-1994, Mooney scorch time of each rubber composition before vulcanization was measured under measurement conditions including a measurement temperature of 125° C. using an L type rotor capable of maximally measuring up to 200 Mooney units.

Specifically, under the above measurement conditions, the torque loaded on a shaft of the rotor was measured and recorded in Mooney unit (this value is a Mooney viscosity), and a viscosity-time curve was made. The minimum value on this curve was rendered MIN torque (minimum Mooney viscosity), a lapsed time (min) to elevation by 5 points in Mooney viscosity from the minimum Mooney viscosity was measured.

<Tensile Test>

In reference with JIS K6301-1995, a tensile test (measurement of tensile stress) for each rubber composition after vulcanization was performed. The vulcanization of each rubber composition was performed at 160° C. for 30 min.

Specifically, each unvulcanized rubber composition was heat-pressed (press vulcanization) at 160° C. for 30 min to make a sheet with a thickness of 2 mm. A test piece of No. 3 dumbbell shape was punched out from this sheet, and stress against a certain elongation (finally elongation after fracture) of the test piece was measured as a tensile stress.

<Hardness Test>

In reference with JIS K6301-1995, a hardness test (A shape) for each rubber composition after vulcanization was performed. The vulcanization of each rubber composition was performed at 160° C. for 30 min.

Specifically, using a test piece (thickness 15 mm) of A shape and a spring type hardness tester, the tester was retained vertically, a pressured face was contacted at a load of 9.807 N such that a pushing needle would be vertical with respect to a measured face of the test piece, and immediately a scale was read to obtain the hardness of the test piece.

As shown in FIG. 3 and Table 2, the rubber compositions in Examples 5 and 6 had longer Mooney scorch time, smaller tensile stress at low strain, and larger elongation after fracture than those of the rubber composition in Comparative Example 3.

It has been found that the rubber compositions in Examples 5 and 6 are more excellent in terms of heat resistance than the rubber composition in Comparative Example 2 because of the combination with the bismaleimide compound.

What is claimed is:

1. A maleimide adduct represented by the following formula (1): 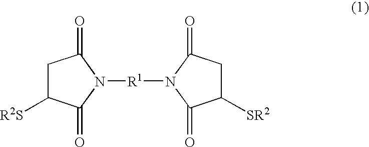
(wherein, R¹ represents an acyclic aliphatic group having 1 to 24 carbon atoms which may have a substituent, a cyclic aliphatic group having 5 to 18 carbon atoms which may have a substituent, an aromatic group having 6 to 18 carbon atoms which may have a substituent, or an alkyl aromatic group having 7 to 24 carbon atoms which may have a substituent, and may include at least one hetero element selected from the group consisting of SO₂, O, N and S, and R²'s each independently represent an organic group having 1 to 24 carbon atoms which have no active hydrogen group and may have a substituent).

2. A maleimide adduct represented by the following formula (2): 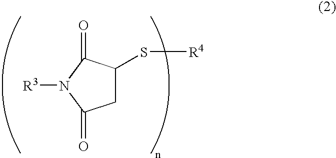
(wherein, n represents an integer of 1 to 4, R³ represents a hydrogen atom, an acyclic aliphatic group having 1 to 24 carbon atoms which may have a substituent, a cyclic aliphatic group having 5 to 18 carbon atoms which may have a substituent, an aromatic group having 6 to 18 carbon atoms which may have a substituent, or an alkyl aromatic group having 7 to 24 carbon atoms which may have a substituent, and may include at least one hetero element selected from the group consisting of SO₂, O, N and S, multiple R³'s may be identical to or different from each other, and R⁴ represents an organic group having 1 to 24 carbon atoms which may have a substituent).

3. A rubber composition, comprising the maleimide adduct according to claim 1 or 2.

4. A resin composition, comprising the maleimide adduct according to claim 1 or 2.
